(19) United States
(12) Patent Application Publication
(10) Pub. No.: US 2025/0215238 A1
(43) Pub. Date: Jul. 3, 2025

(54) AQUEOUS COATING COMPOSITIONS

(71) Applicant: Dow Global Technologies LLC, Midland, MI (US)

(72) Inventors: Rodolfo Di Nápoli Nogueira, São Paulo (BR); Cheng Shen, Shanghai (CN); Beatriz Palma De Andrade Santos, Campinas (BR); Felipe Pinheiro Do Amaral, São Paulo (BR)

(21) Appl. No.: 18/850,256

(22) PCT Filed: May 17, 2022
(86) PCT No.: PCT/CN2022/093225

§ 371 Date: Sep. 24, 2024

(51) Int. Cl. C09D 5/02; C09D 125/14; C09D 131/04; C09D 133/02

(52) U.S. Cl. CPC C09D 5/024; C09D 125/14; C09D 131/04; C09D 133/02

(57) ABSTRACT

Embodiments of the present invention relate to aqueous coating compositions such as paints and other architectural coatings. In one aspect, an aqueous coating composition comprises a binder and a coalescent according to Formula 1: X—O-(AO)ₘH (Formula 1) wherein X is an alkyl group having 4 to 8 carbon atoms, wherein AO is propylene oxide or a mixture of ethylene oxide and propylene oxide in block or random order, wherein m is 1 to 10.

### FIELD

The present invention relates to aqueous coating compositions.

### INTRODUCTION

The continuous pursuit of high performance coatings, such as paint and other architectural coatings, with low volatile organic compounds (VOC) and low odor features has driven the development of new coating formulations. Among the various ingredients in water-based architectural coatings, coalescents, co-solvents and freeze-thaw (F-T) agents are often considered as three major VOC contributors based on the amounts used and their boiling points. Commonly used coalescents (e.g., ester alcohols), co-solvents (e.g., glycols and glycol ethers), and F-T agents (e.g., propylene glycol) are often considered VOC contributors in water-based architectural coating formulations. Coalescents are important in providing good film formation in water-based coatings formulations.

However, it is a challenge to identify coalescents that meet low VOC targets for water-based coating formulations while providing the same or comparable properties to coating formulations made with traditional coalescents having a high VOC content such as 2,2,4-trimethyl-1,3-pentanediol monoisobutyrate, glycol ethers. The key property of a coalescent is to form a homogeneous film and reduce the temperature at which it is formed, but the coalescent should also not hurt other coating properties such as, for example, hardness development, scrub resistance, and stain removal. There is also a need to find new low VOC coalescents that perform well in more variety of resins—such as acrylic, vinyl-acrylic and styrene acrylic emulsions.

It would be desirable to have new aqueous coating compositions having reduced VOC content and/or improved coating performance properties. It would also be desirable to have new low VOC content coalescents that perform well in a variety of resins such as, for example, acrylic, vinyl acrylic, and/or styrene acrylic emulsions.

### SUMMARY

The present invention provides aqueous coating compositions that in some embodiments, have low V(O)C content and/or improved coating performance properties. Examples of such coating performance properties, in some embodiments, include, a reduction in minimum film formation temperature, scrub resistance, and coating stability.

In one aspect, the present invention provides an aqueous coating composition, such as paint, that comprises aqueous coating composition comprising a binder and a coalescent according to Formula 1:

X—O-(AO)ₘH (Formula 1)
wherein X is an alkyl group having 4 to 8 carbon atoms, wherein AO is propylene oxide or a mixture of ethylene oxide and propylene oxide in block or random order, wherein m is 1 to 10.

These and other embodiments are described in more detail in the Detailed Description.

### DETAILED DESCRIPTION

As used herein, “a,” “an,” “the,” “at least one,” and “one or more” are used interchangeably. The terms “comprises,” “includes,” and variations thereof do not have a limiting meaning where these terms appear in the description and claims. Thus, for example, an aqueous composition that includes particles of “a” hydrophobic polymer can be interpreted to mean that the composition includes particles of “one or more” hydrophobic polymers.

Also herein, the recitations of numerical ranges by endpoints include all numbers subsumed in that range (e.g., 1 to 5 includes 1, 1.5, 2, 2.75, 3, 3.80, 4, 5, etc.). For the purposes of the invention, it is to be understood, consistent with what one of ordinary skill in the art would understand, that a numerical range is intended to include and support all possible subranges that are included in that range. For example, the range from 1 to 100 is intended to convey from 1.01 to 100, from 1 to 99.99, from 1.01 to 99.99, from 40 to 60, from 1 to 55, etc.

Some embodiments of the present invention relate to aqueous coating compositions, such as paints or other coatings. Aqueous coating compositions, in some embodiments, comprise a binder and a coalescent according to Formula 1:

X—O-(AO)ₘH (Formula 1)
wherein X is an alkyl group having 4 to 8 carbon atoms, wherein AO is propylene oxide or a mixture of ethylene oxide and propylene oxide in block or random order, wherein m is 1 to 10. In some embodiments. X is n-butyl. In some embodiments, X is 2-ethylhexyl. In some embodiments, m is 3 to 7. In some embodiments, m is 5. In some embodiments, the coalescent comprises 20 weight percent or less of ethylene oxide based on the weight of the coalescent.

In some embodiments, the molecular weight (Mw) of the coalescent is 200 to 500.

In some embodiments, the binder is an aqueous polymeric dispersion that comprises an acrylic polymer, a styrene-acrylic copolymer, a vinyl acetate-acrylic copolymer, an ethylene-vinyl acetate copolymer, or a mixture thereof. In some embodiments where the binder is such an aqueous polymeric dispersion, the aqueous coating composition comprises 5 to 70 weight percent of the polymeric dispersion based on the total weight of the aqueous coating composition. In some embodiments, the aqueous coating composition comprises 10 to 70 weight percent of the polymeric dispersion based on the total weight of the aqueous coating composition. The aqueous coating composition comprises 15 to 60 weight percent of the polymeric dispersion based on the total weight of the aqueous coating composition in some embodiments.

The aqueous coating composition comprises 1 to 20 weight percent of a coalescent according to Formula 1 based on the weight of the binder on a total solids basis in some embodiments. An aqueous coating composition of the present invention, in some embodiments, comprises from 1 to 10 weight percent of a coalescent according to Formula 1 based on the weight of the binder on a total solids basis.

In some embodiments, the coalescent has a VOC content of less than 15% when measured according to EPA Method 24.

### Coalescent

The aqueous coating composition comprises a coalescent according to Formula 1:

X—O-(AO)ₘH (Formula 1)
wherein X is an alkyl group having 4 to 8 carbon atoms, wherein AO is propylene oxide or a mixture of ethylene oxide and propylene oxide in block or random order, wherein m is 1 to 10. In some embodiments, X is n-butyl. In some embodiments, X is 2-ethylhexyl. In some embodiments, m is 3 to 7. In some embodiments, m is 5. In some embodiments, the coalescent comprises 20 weight percent or less of ethylene oxide based on the weight of the coalescent.

By “coalescent” is meant an ingredient that facilitates the film formation of a binder, particularly in an aqueous coating composition that includes a binder that is a dispersion of polymer in an aqueous medium (an aqueous polymeric dispersion) such as, for example, a polymer prepared by emulsion polymerization techniques. An indication of facilitation of film formation is that the minimum film forming temperature (“MFFT”) of the composition including the binder (aqueous polymeric dispersion) is measurably lowered by the addition of the coalescent. In other words, MFFT values are indicative of how efficient a coalescent is for a given aqueous polymeric dispersion; it is desirable to achieve the lowest possible MFFT with the smallest amount of coalescent. MFFTs of the aqueous coating compositions herein are measured using ASTM D 2354 and a 5 mil MFFT bar as described in the Examples section.

In some embodiments, the molecular weight (M) of the coalescent is 200 to 500.

One non-limiting example of a compound according to Formula 1 that can be used as a coalescent in aqueous coating compositions according to some embodiments of the present invention is pentapropyleneglycol 2-ethylhexyl ether. Another non-limiting example of a compound according to Formula 1 that can be used as a coalescent in aqueous coating compositions according to some embodiments of the present invention is Inventive Coalescent 2 described in the Examples section below which is a polyalkylene glycol monobutyl ether.

In some embodiments, an aqueous coating composition of the present invention comprises from 1 to 20% by weight of a coalescent according to Formula 1, based on the weight of the binder on a total solids basis. An aqueous coating composition of the present invention, in some embodiments, comprises from 1 to 10% by weight of a coalescent according to Formula 1 based on the weight of the binder on a total solids basis.

In some embodiments, aqueous coating compositions of the present invention can further comprise one or more other coalescents in addition to coalescent according to Formula 1. In some embodiments, the additional coalescent can be a coalescent according to Formula 1 having a structure different from the first coalescent according to Formula 1. The additional coalescent, in some embodiments, has a VOC content that is similar or lower than the VOC content of a coalescent according to Formula 1.

Coalescents according to Formula 1 can be obtained in a conventional manner by reacting alkylene oxides, such as propylene oxide or a combination of ethylene oxide and propylene oxide, with an initiator in the presence of a catalyst for ring-opening polymerization of alkylene oxides. Polymerization can be bulk polymerization or solution polymerization. Examples of suitable initiators include n-butanol, 2-ethyl hexanol, isobutanol, tert-butanol, hexanol, 2-ocatnol, glycose, or mixtures thereof. The catalyst useful for polymerization of alkylene oxides can be either anionic or cationic, including, for example, potassium hydroxide, boron trifluoride, or double cyanide complex (DMC) catalysts such as zinc hexacyanocobaltate. The alkylene oxides are typically fed into a reactor containing dried initiator and the catalyst at temperatures varying from 50° C. to 140° C. When the pressure in the reactor returns to approximately the same pressure before feeding the alkylene oxides, the polymerization is usually considered complete. The products are neutralized with an acid, such as acetic or phosphoric acid, or a base, such as sodium hydroxide (in case of acid catalysts such as boron trifluoride), to avoid catalyst oxidation.

### Binder

In addition to the coalescent of Formula 1, aqueous coating compositions of the present invention further comprise a binder. The binder can be part of an aqueous polymeric dispersion that comprises a polymer, oligomer, prepolymer, or a combination thereof in an aqueous medium. In some embodiments, the aqueous polymeric dispersion forms a film upon evaporation of water and can be reactive or non-reactive, depending on the desired formulation. By “aqueous medium” is meant herein a medium including at least 40%, by weight based on the weight of the medium, water. The polymer, oligomer, prepolymner, or combination in the aqueous polymeric dispersion is often referred to as a binder. The choice of binder is not particularly critical, and the binder can be selected from all type of binders known in the art including, for example, an acrylic polymer, a styrene-acrylic copolymer, a vinyl acetate-acrylic copolymer, an ethylene-vinyl acetate copolymer, or a mixture thereof, and hybrids of these and other chemistries. In some embodiments, the binder is a binder that is suitable for use for interior wall paint. In some embodiments, the binder is a binder that is suitable for use in exterior paint. In some embodiments, the binder is a binder that is suitable for use in a waterproofing paint, including one-component waterproofing paints and/or two-component paints.

The average particle diameter of the polymer particles in the dispersion is not particularly critical, and advantageously is from 40 nm to 1000 nm, preferably from 50 nm to 600 nm. Particle diameters herein are those measured by a Zetasizer Nano ZS from Malvern Panalytical Ltd.

### Aqueous Coating Compositions

In some embodiments, an aqueous coating composition of the present invention comprises: (a) a binder; and (d) a coalescent according to Formula 1 as described hereinabove. In some embodiments, an aqueous coating composition of the present invention comprises: (a) a binder; (b) optionally, a pigment; (c) water; and (d) a coalescent according to Formula 1 as described hereinabove. In some embodiments, an aqueous coating composition of the present invention comprises: (a) a binder; (b) optionally, a pigment; (c) water; (d) a coalescent according to Formula 1 as described hereinabove; and (e) one or more nonionic surfactants. In some embodiments, an aqueous coating composition of the present invention comprises: (a) a binder; (b) optionally, a pigment; (c) water; (d) a coalescent according to Formula 1 as described hereinabove; (e) one or more nonionic surfactants; and (f) one or more of a thickener, a dispersant, and a filler.

Various embodiments of aqueous coating compositions of the present invention can be employed in uses such as, for example, wall paints, floor coatings, ceiling paints, exterior paints, and window frame coatings.

Aqueous coating compositions of the present invention can be prepared by techniques which are well known in the coatings art. For example, preparation of an aqueous coating composition includes a grind stage. For the grind stage, a number of components of the aqueous coating composition, such as the pigment, as well as other materials that may not homogenize under low shear mixing and are selected for a particle size reduction, can be combined with water to be ground and/or dispersed (e.g. via a mill under high shear conditions). Other components, such as defoamer and/or wetting agent, among others, may be utilized in the grind stage.

The grind stage can provide that resultant particles have an average particle diameter from 0.1 μm to 100 μm. All individual values and subranges from 0.1 μm to 100 μm are included; for example, resultant particles may have an average particle diameter from a lower limit of 0.1, 0.5, or 1.0 μm to an upper limit of 100, 75, or 50 μm.

Following the grind stage, a let-down stage may be performed. The composition resulting from the grind stage (e.g., a number of ground and/or dispersed aqueous coating composition components) can be combined with the coalescent according to Formula 1 and the remaining components utilized to form the aqueous coating composition.

The aqueous coating composition may include, in addition to the aqueous polymeric dispersion (with binder), coalescent according to Formula 1, and optional pigment(s), conventional coatings adjuvants such as, for example, wetting agents, extenders, emulsifiers, plasticizers, curing agents, buffers, neutralizers, rheology modifiers, surfactants, humectants, biocides, antifoaming agents, UV absorbers, fluorescent brighteners, light and/or heat stabilizers, biocides, chelating agents, dispersants, colorants, waxes, and water-repellants.

The aqueous coating compositions disclosed herein may include a wetting agent, which may also be referred to as a surfactant and/or a dispersant in some embodiments. “Wetting agent” as used herein refers to a chemical additive that can reduce the surface tension and/or improve separation of particles of the aqueous coating compositions disclosed herein. Examples of wetting agents include, but are not limited to, alcohol ethoxylate wetting agents, polycarboxylate wetting agents, anionic wetting agents, zwitterionic wetting agents, non-ionic wetting agents, and combinations thereof. Specific examples of wetting agents that can be used in some embodiments include sodium bis(tridecyl) sulfosuccinate, sodium di(2-ethylhexyl) sulfosuccinate, sodium dihexylsulfosuccinate, sodium dicyclohexylsulfosuccinate, sodium diamylsulfosuccinate, sodium diisobutylsulfosuccinate, disodium iso-decylsulfosuccinate, the disodium ethoxylated alcohol half ester of sulfosuccinic acid, disodium N-octasulfosuccinamate, and sulfated ethoxylated nonylphenol, among others. Examples of commercially available wetting agents include, for example, ECOSURF™ EH-9 and TERGITOL™ NP-10 available from The Dow Chemical Company, SURFYNOL 104 available from Evonik, and BYK-346 and BYK-349 polyether-modified siloxanes both available from BYK, among others.

The aqueous coating composition may include from 0.01 to 10 weight percent of the wetting agent based upon a total weight of the aqueous coating composition. All individual values and subranges from 0.01 to 10 weight percent are included; for example, the aqueous coating composition may include the wetting agent from a lower limit of 0.01, 0.1, 0.2, 1.0 or 2.0 weight percent to an upper limit of 10, 8, 7, 5, 4, or 3 weight percent based upon the total weight of the aqueous coating composition.

The pigment can be selected from the wide range of materials known to those skilled in the art of coatings, including, for example, organic and inorganic-colored pigments. Examples of suitable pigments and extenders include titanium dioxide such as anatase and rutile titanium dioxides; zinc oxide; antimony oxide; iron oxide; magnesium silicate; calcium carbonate; aluminosilicates; silica; various clays such as kaolin and delaminated clay; and lead oxide. It is also contemplated that the aqueous coating composition may also contain opaque polymer particles, such as, for example, ROPAQUE™ Opaque Polymers (available from The Dow Chemical Company). Also contemplated are encapsulated or partially encapsulated opacifying pigment particles; and polymers or polymer emulsions adsorbing or bonding to the surface of pigments such as titanium dioxide such as, for example, EVOQUE™ polymers (available from The Dow Chemical Company); and hollow pigments, including pigments having one or more voids.

Titanium dioxide is a typical pigment used to achieve hiding in architectural paints.

The amounts of pigment and extender in the aqueous coating composition vary from a pigment volume concentration (PVC) of 0 to 85 and thereby encompass coatings otherwise described in the art, for example, as clear coatings, stains, flat coatings, satin coatings, semi-gloss coatings, gloss coatings, primers, textured coatings, and the like. The aqueous coating composition herein expressly includes architectural, maintenance, and industrial coatings, caulks, sealants, and adhesives. The pigment volume concentration is calculated by the following formula:

PVC (%)=(volume of pigment(s),+volume extender(s)×100)/(total dry volume of paint).

The solids content of the aqueous coating composition may be from 10% to 70% by volume. The viscosity of the aqueous coating composition may be from 50 KU to 200 KU when measured according to in accordance with ASTM D562. In some embodiments, the viscosity of the aqueous coating composition may be from 80 KU to 120 KU when measured according to in accordance with ASTM D562. Viscosities appropriate for different application methods vary considerably, as is known to those skilled in the art.

The aqueous coating composition disclosed herein can be utilized to form coatings. These coatings may be used for a number of different coating applications such as industrial coating applications, architectural coating applications, automotive coating applications, outdoor furniture coating applications, among others.

In use, various embodiments of aqueous coating compositions of the present invention can typically be applied to a substrate such as, for example, wood, metal, plastic, marine and civil engineering substrates, previously painted or primed surfaces, weathered surfaces, and cementitious substrates such as, for example, concrete, stucco, and mortar.

Drying of the aqueous coating compositions to provide a coating may be allowed to proceed under ambient conditions such as, for example, at 5° C. to 35° C. or the coating may be dried at elevated temperatures such as, for example, from greater than 35° C. to 80° C.

Some embodiments of the invention will now be described in detail in the following Examples.

### EXAMPLES

The following examples are given to illustrate the invention and should not be construed as limiting its scope. All parts and percentages are by weight unless otherwise indicated.

### Coalescents

The Examples below use different coalescents. Two of the coalescents (Inventive Coalescents 1-2) are coalescents according to Formula 1, and represent coalescents that can be used in embodiments of aqueous coating compositions of the present invention. Inventive Coalescents 1 and 2 are prepared from the following recipes:

TABLE 1
Inventive Coalescent 1 Ingredients

| Raw Material | Target (wt. %) |
|---|---|
| 2-Ethylhexanol, 99.5% | 30.89% |
| Propylene Oxide | 68.92% |
| Potassium Hydroxide Aqueous Solution | 0.18% |
| (45-50%) | |

TABLE 2
Inventive Coalescent 1 Ingredients

| Raw Material | Target (wt. %) |
|---|---|
| n-Butanol (The Dow Chemical Company) | 16.25% |
| Ethylene Oxide (high purity) | 5.88% |
| Propylene Oxide | 77.66% |
| Potassium Hydroxide (solid) | 0.21% |

The Inventive Coalescents are obtained by reacting the alkylene oxides (as specified above) with an initiator in the presence of a catalyst for ring-opening polymerization of alkylene oxides. The polymerization is conducted in a two liter reactor. For Inventive Coalescent 1, the initiator is 2-ethylhexanol and for Inventive Coalescent 2, the initiator is n-Butanol. The catalyst used for the polymerizations is potassium hydroxide. The alkylene oxides are fed into a reactor containing dried initiator (2-ethylhexanol or n-butanol) and the catalyst at a temperature of 120° C. When the pressure in the reactor returns to approximately the same pressure before feeding the alkylene oxides, the polymerization is considered complete. These products are neutralized with an acid, such as acetic or phosphoric acid, to avoid catalyst oxidation. Each of the Inventive Coalescents are coalescent according to Formula I:

X—O-(AO)ₘH (Formula 1).

For Inventive Coalescent A (“IC-1”), X is 2-ethylhexanol, AO is propylene oxide, and m has an average value of 5. Inventive Coalescent 1 is a pentapropylene glycol 2-ethylhexyl ether. For Inventive Coalescent 2 (“IC-2”, X is n-butanol, AO is a mixture of ethylene oxide and propylene oxide in random order, and n has an average value of 6. Inventive Coalescent 2 is a polyalkylene glycol monobutyl ether.

For comparison, the Comparative Examples use conventional coalescents. Comparative Coalescent A (“CC-A”) is UCAR™ Filmer IBT, which is 2,2,4-trimethyl-1,3-pentanediol monoisobutyrate, commercially available from The Dow Chemical Company. Comparative Coalescent B (“CC-B”) is bi-dipropylene glycol n-butyl ether adipate. Comparative Coalescent C (“CC-C”) is triethylene glycol bis(2-ethylhexanoate). Comparative Coalescent D (“CC-D”) is polyalkylene glycol 2-ethylhexyl ether.

The properties of the coalescents are shown in Table 3:

TABLE 3

| | | | | Ethylene |
|---|---|---|---|---|
| | | | Boiling | oxide |
| | | Water | Point | (EO) |
| Coalescent | Chemical Name | Solubility | (° C.) | % by wt. |
| UCAR ™ | 2,2,4-trimethyl-1,3- | 0.12 g/L | 255° C. | 0 |
| Filmer | pentanediol | (at 20° C.) | | |
| IBT | monoisobutyrate | | | |
| (CC-A) | | | | |
| CC-B | bis-dipropylene glycol | <1.0 (at | 485° C. | 0 |
| | n-butyl ether adipate | 20° C.) | | |
| CC-C | triethylene glycol | negligible | 344° C. | 31.6 |
| | bis(2-ethylhexanoate | | | |
| CC-D | polyalkylene glycol | dispersible | decomposes | 23.9 |
| | 2-ethylhexyl ether | in water | before | |
| | | | boiling | |
| | | | point | |
| IC-1 | pentapropylene glycol | — | — | 0 |
| | 2-ethyhexyl ether | | | |
| IC-2 | polyalkylene glycol | — | — | 5.0 |
| | monobutyl ether | | | |

### Binders

The binders used in the Examples are RHOPLEX AC-630 LOX (“Binder A”), which is an aqueous polymeric dispersion with an acrylic polymer (50 weight percent solids; MFFT=17° C.) commercially available from The Dow Chemical Company, and ROVACE™ NUEVA 4838 (“Binder B”), which is an aqueous polymeric dispersion with a vinyl acrylic polymer (50 weight percent solids; MFFT=13° C.) commercially available from The Dow Chemical Company.

### Binder-Coalescent Formulations

Various formulations of the coalescents and binders are prepared at coalescent loadings of 4%, 6%, 8%, and 10% weight percent of coalescent based on the weight of the binder on a total solids basis, as shown in Table 4

TABLE 4

| Binder | Coalescent | Wt. % Coalescent |
|---|---|---|
| Binder B | CC-C | 4% |
| Binder B | CC-C | 6% |
| Binder B | CC-C | 8% |
| Binder B | CC-C | 10% |
| Binder B | IC-1 | 4% |
| Binder B | IC-1 | 6% |
| Binder B | IC-1 | 8% |
| Binder B | IC-1 | 10% |
| Binder B | IC-2 | 4% |
| Binder B | IC-2 | 6% |
| Binder B | IC-2 | 8% |
| Binder B | IC-2 | 10% |
| Binder A | CC-C | 4% |
| Binder A | CC-C | 6% |
| Binder A | CC-C | 8% |
| Binder A | CC-C | 10% |
| Binder A | IC-1 | 4% |
| Binder A | IC-1 | 6% |
| Binder A | IC-1 | 8% |
| Binder A | IC-1 | 10% |
| Binder A | IC-2 | 4% |
| Binder A | IC-2 | 6% |
| Binder A | IC-2 | 8% |
| Binder A | IC-2 | 10% |
| Binder B | CC-B | 4% |
| Binder B | CC-B | 6% |
| Binder B | CC-B | 8% |
| Binder B | CC-B | 10% |
| Binder B | CC-A | 4% |
| Binder B | CC-A | 6% |
| Binder B | CC-A | 8% |
| Binder B | CC-A | 10% |
| Binder A | CC-B | 4% |
| Binder A | CC-B | 6% |
| Binder A | CC-B | 8% |
| Binder A | CC-B | 10% |
| Binder A | CC-A | 4% |
| Binder A | CC-A | 6% |
| Binder A | CC-A | 8% |
| Binder A | CC-A | 10% |
| Binder A | CC-D | 4% |
| Binder A | CE-D | 6% |
| Binder A | CC-D | 8% |
| Binder A | CC-D | 10% |
| Binder B | CC-D | 4% |
| Binder B | CC-D | 6% |
| Binder B | CC-D | 8% |
| Binder B | CC-D | 10% |

The minimum film formation temperature (MFFT) of the above binder-coalescent blends and the volatile organic compound (VOC) contents of the coalescents are measured using the test methods described at the end of the Examples section. MFFT is the temperature where the polymer will form a homogeneous and clear film, without cracked aspects. The results are shown in Tables 5 and 6:

TABLE 5

| VOC Content (by wt.) | CC-A | CC-B | CC-C | IC-1 | IC-2 |
|---|---|---|---|---|---|
| VOC - EPA method 24 | >99% | 0.5% | 1.2% | 13.3% | 10.8% |

TABLE 6

| Tested Property | Wt. % | | | | | | |
|---|---|---|---|---|---|---|---|
| (unit: ° C.) | Coalescent | CC-A | CC-B | CC-C | CC-D | IC-1 | IC-2 |
| MFFT Binder A | 4% | 9.1 | 14.6 | 14.4 | 15.4 | 10.0 | 11.1 |
| (Acrylic) - | | | | | | | |
| Average | | | | | | | |
| MFFT Binder A | 6% | 4.4 | 13.2 | 13.9 | 11.1 | 7.0 | 8.0 |
| (Acrylic) - | | | | | | | |
| Average | | | | | | | |
| MFFT Binder A | 8% | 0.2 | 10.7 | 15.2 | 8.7 | 3.9 | 6.9 |
| (Acrylic) - | | | | | | | |
| Average | | | | | | | |
| MFFT Binder A | 10% | −0.9 | 9.4 | 13.3 | 7.8 | 3.3 | 5.2 |
| (Acrylic) - | | | | | | | |
| Average | | | | | | | |
| MFFT Binder B | 4% | 7.8 | 7.6 | 6.1 | 8.1 | 6.1 | 6.5 |
| (Vinyl Acrylic) - | | | | | | | |
| Average | | | | | | | |
| MFFT Binder B | 6% | 5.6 | 7.5 | 5.6 | 5.8 | 4.2 | 5.4 |
| (Vinyl Acrylic) - | | | | | | | |
| Average | | | | | | | |
| MFFT Binder B | 8% | 2.0 | 3.0 | 4.6 | 5.6 | 3.3 | 5.0 |
| (Vinyl Acrylic) - | | | | | | | |
| Average | | | | | | | |
| MFFT Binder B | 10% | <2.0 | <2.0 | <4.0 | 4.6 | <2.0 | 4.0 |
| (Vinyl Acrylic) - | | | | | | | |
| Average | | | | | | | |

With the exception of Comparative Coalescent A, Inventive Coalescent 1 shows better performance (lower MFFT) than Comparative Coalescents B-D. While Comparative Coalescent A has lower MFFT than Inventive Coalescent 1, Comparative Coalescent A has an extremely high VOC content making it less desirable as a coalescent. Inventive Coalescent 2 also exhibits good MFFT reduction efficiency, mainly with the acrylic binder (Binder A).

### Preparation of Paint Formulations

Paint formulations (types of aqueous coating compositions) are prepared to evaluate the performance of the Inventive Coalescents relative to the Comparative Coalescents. Two paint formulations (a Standard Formulation and a Premium Formulation) are used with each of the Coalescents being evaluated in each formulation. Aqueous coating compositions (paint formulations) made with an Inventive Coalescent are referred to as Inventive Coating Compositions, and aqueous coating compositions (paint formulations) made with a Comparative Coalescent are referred to as Comparative Coating Compositions.

Each of the Inventive and Comparative Coating Compositions are prepared as follows.

### Standard Formulation

Water is added to a ten liters plastic beaker, followed by the specified dispersants (Potassium tripolyphosphate and TAMOL™ 1124), and wetting agent (TRITON™ CF-10) with stirring by dispersion plate at around 400 rpm. Titanium dioxide is added and, in the sequence, the defoamer (Foamaster 111). The pigment extenders are added in the following sequence: Omyacarb 1, Omyacarb 5 and Glomax LL. Biocide is added followed by solvent (ethylene glycol). A thickener (Natrosol 250HBR) is slowly added into the above mixture, and the mixture stirred for two minutes. Water is added to complete the dispersion of materials. The dispersing speed is raised to 2000 rpm with gradually increasing viscosity.

This mixture is kept dispersing for 30 minutes or even longer until no particles having a size larger than 50 microns are observed in order to assure homogeneous dispersion.

Polymeric pigment, ROPAQUE™ Ultra, is added in the formulation, followed by water and defoamner (Foamaster 111).

The specified binder (ROVACE™ NUEVA 4838) is then added to the mixture, followed by ammonia (28%) and water. A small size dispersion plate is used for stirring at 1000 rpm for 10 minutes.

The specified thickeners and rheology modifier (ACRYSOL™ RM-5000, RM-725), biocide (Rozone 2000) and the remaining water are then added into the mixture with stirring for another 10 minutes. Rheology modifiers are added slowly to achieve a KU viscosity from 90.0 to 100.0 KU and a pH from 8.5 to 9.0 (adjusting with ammonia).

Finally, the coalescents are added into the formulation after fractioning in different parts.

TABLE 7
Standard Formulation

| Material | | |
|---|---|---|
| (Supplier) | Function | Weight % |
| Grind | | |
| Water | Water | 17.76% |
| Potassium tripolyphosphate | Dispersant | 0.11% |
| (Sigma-Aldrich) | | |
| TAMOL ™ 1124 | Dispersant | 0.64% |
| (The Dow Chemical Company | | |
| (“Dow”)) | | |
| TRITON ™ CF-10 | Nonionic Surfactant | 0.22% |
| (Dow) | | |
| Ti-Pure R-902 | Pigment | 12.18% |
| (The Chemours Company) | (Titanium Dioxide) | |
| Foamaster 111 | Defoamer | 0.16% |
| (BASF SE) | | |
| Omyacarb 1 | Pigment Extender | 9.46% |
| (Omya) | | |
| Omyacarb 5 | Pigment Extender | 9.75% |
| (Omya) | | |
| Glomax LL | Pigment Extender | 8.50% |
| (Imerys Performance Materials) | | |
| Kathon LX 1.5% | Biocide | 0.16% |
| (DuPont) | | |
| Ethylene Glycol | Solvent | 0.80% |
| (Sigma-Aldrich) | | |
| Natrosol 250 HBR | Nonionic Thickener | 0.32% |
| (Ashland) | | |
| Water | Water | 8.98% |
| End Grind | | |
| Let Down | | |
| ROPAQUE ™ Ultra | Polymeric Pigment | 5.37% |
| (Dow) | | |
| Water | Water | 3.86% |
| Foamaster 111 | Defoamer | 0.04% |
| (BASF SE) | | |
| ROVACE ™ NUEVA 4838 | Binder (vinyl acrylic) | 18.17% |
| (Dow) | | |
| Ammonia (28%) | Neutralizing Agent | 0.10% |
| (Sigma-Aldrich) | (base) | |
| Water | Water | 2.44% |
| ACRYSOL ™ RM-5000 | Nonionic Thickener | 0.64% |
| (Dow) | | |
| Rozone 2000 | Biocide | 0.21% |
| (DuPont) | | |
| ACRYSOL ™ RM-725 | Nonionic Thickener | 0.10% |
| (Dow) | | |

### Premium Formulation

Water is added to a ten liters plastic beaker, followed by the specified dispersants (TAMOL™ 2002), followed by solvent (propylene glycol) and wetting agent (TRITON™ HW-1000) with stirring by dispersion plate at around 400 rpm. Titanium dioxide is added and, in the sequence, the defoamer (Foamaster 111). The pigment extenders are added in the following sequence Omyacarb 5, Mistron Monomix, Glomax LL and Celite 400. Biocide (Kathon LX 1.5% and Rozone 2000) is added. A thickener (Natrosol 250HBR) is slowly added into the above mixture, and the mixture stirred for two minutes. Water is added to complete the dispersion of materials followed by buffer (ammonia 28%). The dispersing speed is raised to 2000 rpm with gradually increasing viscosity.

This mixture is kept dispersing for 30 minutes or even longer until no particles having a size larger than 50 microns are observed to assure homogeneous dispersion.

Polymeric pigment, ROPAQUE™ Ultra, is added in the formulation, followed by water and defoamer (Foamnaster 11).

The specified binder (RHOPLEX™ AC-630 LOX) is then added to the mixture, followed by ammonia (28%). A small size dispersion plate is used for stirring at 1000 rpm for 10 minutes.

The specified thickeners and rheology modifier (ACRYSOL™ RM-5000, RM-725) are then added into the mixture with stirring for another 10 minutes. Rheology modifiers are added slowly to achieve a KU viscosity from 90.0 to 100.0 KU and a pH from 8.5 to 9.0 (adjusting with ammonia).

Finally, the coalescents are added into the formulation after fractioning in different parts.

TABLE 8
Premium Formulation

| Material | | |
|---|---|---|
| (Supplier) | Function | Weight % |
| Grind | | |
| Water | Water | 23.65% |
| TAMOL ™ 2002 | Dispersant | 0.78% |
| (Dow) | | |
| Propylene Glycol | Solvent | 1.16% |
| (Dow) | | |
| TRITON ™ HW-1000 | Surfactant | 0.20% |
| (Dow) | | |
| Ti-Pure R-902 | Pigment (Titanium | 17.02% |
| (The Chemours Company) | Dioxide) | |
| Foamaster 111 | Defoamer | 0.15% |
| (BASF SE) | | |
| Omyacarb 5 | Pigment Extender | 3.51% |
| (Omya) | | |
| Mistron Monomix | Pigment Extender | 2.90% |
| (Imerys Performance Materials) | | |
| Glomax LL | Pigment Extender | 5.01% |
| (Imerys Performance Materials) | | |
| Celite 400 | Pigment Extender | 5.01% |
| (Imerys Performance Materials) | | |
| Kathon LX 1.5% | Biocide | 0.15% |
| (DuPont) | | |
| Rozone 2000 | Biocide | 0.20% |
| (DuPont | | |
| Natrosol 250 HBR | Nonionic Thickener | 0.10% |
| (Ashland) | | |
| Water | Water | 3.80% |
| Ammonia (28%) | Neutralizing Agent | 0.17% |
| (Sigma-Aldrich) | (base) | |
| End Grind | | |
| Let Down | | |
| ROPAQUE ™ Ultra | Polymeric Pigment | 3.36% |
| (Dow) | | |
| Foamaster 111 | Defoamer | 0.20% |
| (BASF SE) | | |
| RHOPLEX AC-630 LOX | Binder (Acrylic) | 31.50% |
| (Dow) | | |
| Ammonia (28%) | Neutralizing Agent | 0.05% |
| (Sigma-Aldrich) | (base) | |
| ACRYSOL ™ RM-725 | Nonionic Thickener | 0.42% |
| (Dow) | | |
| ACRYSOL ™ RM-5000 | Nonionic Thickener | 0.68% |
| (Dow) | | |

The Coalescents are added separately after the Standard and Premium Formulations are prepared. A Standard Formulation and a Premium Formulation are prepared using each of the Inventive Coalescents and each of the Comparative Coalescents. The coalescent is added in an amount to provide 10 weight percent coalescent based on the weight of the binder on a total solids. The Standard Formulation included 0.9 weight percent coalescent based on total coating weight. The Premium Formulation included 1.6 weight percent coalescent based on total coating weight.

The Standard and Premium Formulations had the following properties:

TABLE 9

| Property | Standard | Premium |
|---|---|---|
| Solids volume (% vol.) | 33.25% | 34.53% |
| Pigment Volume Concentration (pigment | 64.9 | 46.1 |
| weight/pigment + binder weight) | | |
| Density (g/L) | 1.38 | 1.31 |
| Coalescent Concentration (based on solids | 10% by wt. | 10% by wt. |
| in resin) | | |

The paint stability and scrub resistance of each Formulation are measured. Paint stability is measured by medium shear rate viscosity changes (“KU Viscosity”, in Krebs Units—KU) with a viscosimeter as described further below, and the results are shown in Table 10. Scrub resistance is measured by the number of scrub cycles to remove paint film in the presence of an abrasion paste as described further below, and the results are shown in Table 11. The column labels in Tables 10 and 11 refer to the Coalescent used in that Formulation.

TABLE 10

| Tested Property - | | | | | | |
|---|---|---|---|---|---|---|
| KU Viscosity | CC-A | CC-B | CC-C | CC-D | IC-1 | IC-2 |
| Standard Formulation | | | | | | |
| KU Viscosity - No coalescent | 90.7 | 90.7 | 90.7 | 90.7 | 90.7 | 90.7 |
| KU Viscosity - After | 92.2 | 91.8 | 92.1 | 84.8 | 92.5 | 88.2 |
| coalescent addition | | | | | | |
| KU Viscosity - 24 hours after | 91.9 | 91.8 | 91.9 | 85.3 | 92.2 | 88.3 |
| coalescent addition | | | | | | |
| KU Viscosity - 10 days after | 90.4 | 89.7 | 90.3 | 84.5 | 90.3 | 87.1 |
| coalescent addition at room | | | | | | |
| temperature | | | | | | |
| ΔKU (KU changes after | +1.5 | +1.1 | +1.4 | −5.9 | +1.8 | +2.5 |
| coalescent addition → KU no | | | | | | |
| coalescent - KU after | | | | | | |
| coalescent addition) | | | | | | |
| ΔKU (KU (10 days) - KU | −1.8 | −2.1 | −1.8 | 0.3 | −2.2 | −1.1 |
| (coalescent addition)) | | | | | | |
| Premium Formulation | | | | | | |
| KU Viscosity - No coalescent | 112.8 | 112.8 | 112.8 | 112.8 | 112.8 | 112.8 |
| KU Viscosity - After | 112.6 | 113.9 | 114.2 | 72.8 | 108.2 | 100.5 |
| coalescent addition (10% by | | | | | | |
| wt. based on solids in resin) | | | | | | |
| KU Viscosity - 24 hours after | 114.5 | 115.4 | 116.2 | 78.6 | 110.5 | 104.2 |
| coalescent addition | | | | | | |
| KU Viscosity - 10 days after | 110.6 | 114.1 | 116.2 | 81.7 | 110.2 | 105.4 |
| coalescent addition | | | | | | |
| ΔKU (KU changes after | −0.2 | 1.1 | 1.4 | −40.0 | −4.6 | −12.3 |
| coalescent addition → KU no | | | | | | |
| coalescent - KU after | | | | | | |
| coalescent addition) | | | | | | |
| ΔKU (KU (10 days) - KU | −2.0 | +0.2 | +2.0 | +8.9 | +2.0 | +4.9 |
| (coalescent addition)) | | | | | | |

TABLE 11

| Tested Property - | | | | | | |
|---|---|---|---|---|---|---|
| Scrub Resistance | CC-A | CC-B | CC-C | CC-D | IC-1 | IC-2 |
| Standard Formulation | | | | | | |
| Scrub resistance | 307 | 289 | 318 | 290 | 280 | 310 |
| cycles average | | | | | | |
| Premium Formulation | | | | | | |
| Scrub resistance | 670 | 640 | 582 | 547 | 589 | 659 |
| cycles average | | | | | | |

Regarding paint stability, all of the Formulations, other than ones made with Comparative Coalescent D, performed well, demonstrating an ability to keep KU variation lower than 10.0 units. This is important for paint formulators. Large variations will require paint formulators to modify the formulation to achieve proper viscosity, for example, by adding more thickeners. As noted above, the Formulations made with Comparative Coalescent D had large variations, reaching 40 units in Premium Formulations.

Regarding scrub resistance, the Formulations made with Inventive Coalescent 2 increased the number of cycles relative to Formulations made with Comparative Coalescent C, while the other Formulations kept similar performance. Formulations made with Comparative Coalescent 4 had poor performance, mainly in reducing MFFT and in paint stability, as the viscosity decreases too much after its addition.

### Test Methods

### Minimum Film Formation Temperature

MFFT is generally measured using ASTM D2354-10(2018). To evaluate the coalescents' capability of lowering the MFFT of the emulsions, mixtures of different concentrations of coalescents in pure emulsions are prepared. Specific weights of the emulsion are added to glass flasks and mechanically stirred at 500 rpm. The desired weight of the coalescent is added and the system is stirred for 5 minutes. Flasks are kept closed until the moment of application of the films.

The MFFT instrument and the thermostatic bath are turned on at least two hours before starting the experiment to ensure the stability of the temperature gradient. The lid of the equipment is lifted, and the steel plate is cleaned with ethanol. A polyester sheet is placed over the steel plate and secured by one of its shorter sides. A 75 μm film applicator with triple reservoir is placed on the same edge of the sheet where it is secured to the steel plate. Around 2 ml of sample are added to each reservoir of the applicator and the three films are immediately cast. The lid is put back on.

After the films are completely dry (drying time of at least 20 minutes), the lid is lifted, and the positions of the thermocouples are registered on the polyester sheet. The sheet is removed from the equipment and placed over a dark background, under a bright light. The integrity of the films is visually evaluated. The position from which the film is no longer continuous, or in which it starts to show cracks or opacity, is considered the point of MFFT. The temperature of the thermocouple related to that position is reported. Each mixture of coalescent and emulsion is tested in triplicate. The reported results are averages between individual values.

### Scrub Resistance

The scrub resistance of the Formulations is measured in accordance with NBR 14940.

### Paint Stability (KU Viscosity)

The paint stability of each Formulation is evaluated using KU viscosity measured in accordance with ASTM D562.

### VOC Content

The VOC contents of the Coalescents are measured using EPA Method 24.

1. An aqueous coating composition comprising a binder and a coalescent according to Formula 1:
X—O-(AO)ₘH (Formula 1)
wherein X is an alkyl group having 4 to 8 carbon atoms, wherein AO is propylene oxide or a mixture of ethylene oxide and propylene oxide in block or random order, wherein m is 1 to 10.

2. The coating composition of claim 1, wherein the coalescent comprises 20 weight percent or less of ethylene oxide based on the weight of the coalescent.

3. The coating composition of claim 1, wherein the molecular weight (M_{w}) of the coalescent is from 200 to 500.

4. The coating composition of any of the preceding claims, wherein the binder is an aqueous polymeric dispersion that comprises an acrylic polymer, a styrene-acrylic copolymer, a vinyl acetate-acrylic copolymer, an ethylene-vinyl acetate copolymer, or a mixture thereof.

5. The coating composition of claim 4, wherein the aqueous coating composition comprises 5 to 70 weight percent of the polymeric dispersion based on the total weight of the aqueous coating composition.

6. The coating composition of any of the preceding claims, wherein the aqueous coating composition comprises 1 to 20 weight percent of the coalescent based on the weight of the binder on a total solids basis.

7. The coating composition of any of the preceding claims, wherein the coalescent has a VOC content of less than 15% when measured according to EPA Method 24.
